(19) United States
(12) Patent Application Publication
(10) Pub. No.: US 2015/0002069 A1
(43) Pub. Date: Jan. 1, 2015

(54) DRIVING SWITCHING SYSTEM APPLIED TO MOTORS

(71) Applicant: FEELING TECHNOLOGY CORP., HSINCHU (TW)

(72) Inventor: HSUAN-CHUAN CHEN, HSINCHU (TW)

(73) Assignee: FEELING TECHNOLOGY CORP., HSINCHU (TW)

(21) Appl. No.: 14/023,738

(22) Filed: Sep. 11, 2013

(30) Foreign Application Priority Data
Jun. 28, 2013 (TW) 102123170

(51) Int. Cl. H02P 23/00

(52) U.S. Cl. CPC H02P 23/00
USPC 318/504

(57) ABSTRACT

A driving switching system includes an H-bridge circuit, at least a kickback voltage detection module and at least a driving module. The H-bridge circuit includes a first P-type MOSFET, a first N-type MOSFET, a second P-type MOSFET and a second N-type MOSFET. The first N-type MOSFET connects the first P-type MOSFET to have a first connection terminal, and the second N-type MOSFET connects the second P-type MOSFET to have a second connection terminal, in which both the terminals are connected to a coil. The kickback voltage detection module is used to detect a first kickback voltage at the first connection terminal and a second kickback voltage at the second connection terminal. The driving module switches the P-type MOSFET and the N-type MOSFET so as to drive a motor as the first or the second kickback voltage reaches a first or a second threshold.

This application claims the benefit of Taiwan Patent Application Serial No. 102123170 filed on Jun. 28, 2013, the subject matter of which is incorporated herein by reference.

### BACKGROUND OF INVENTION

1. Field of the Invention

The invention relates to a driving switching system applied to motors, and more particularly to the driving switching system for motors that can base on the first kickback voltage and the second kickback voltage to determine the switching among various MOSFETs to drive the motor, as preset threshold voltages are reached.

2. Description of the Prior Art

The motor is one of the popular mechanic parts in normal life. In driving circuit of the conventional motor, the H-bridge circuit and the driving module are two important elements. Generally, the H-bridge circuit includes two P-type Metal-Oxide-Semiconductor Field-Effect Transistors (PMOSFETs) and two N-type Metal-Oxide-Semiconductor Field-Effect Transistors (NMOSFETs). In structuring, a pair of one PMOSFET and one NMOSFET in series is electrically coupled with another pair of PMOSFET and NMOSFET in series through a coil, in which the two PMOSFETs are electrically connected to the source power VDD, while the two NMOSFET are electrically connected to the ground VSS. The driving module is electrically connected the aforesaid two PMOSFETs and the aforesaid two NMOSFETs.

In the art, the H-bridge circuit is to drive the motor. As the H-bridge circuit drives the motor, it may meet a situation that the current is terminated during the commutation of the motor; such that two ends of the coil (one at the PMOSFET and another at the NMOSFET) would generate a kickback voltage. Sometimes, the kickback voltage may be higher than the source power VDD or lower than the ground VSS. As an ill consequence, the aforesaid PMOSFETs and NMOSFETs may be damaged, and further the motor may be degraded or even shutdown.

Further, for the nature of the PMOSFET and the NMOSFET, the parasitic diodes may extend the tolerance of the kickback voltage (for example, from VDD+Vd to VSS−Vd). However, in practice, the formation of the kickback voltage usually interferes the driving of the motor or leads to the damage of the IC through the CMOS latch-up phenomenon.

It is clearly that the kickback voltage would damage the PMOSFET and the NMOSFET in the motor's driving circuit, and would dysfunction the motor to some degree. Further, the induced latch-up effect would also damage the IC. Hence, it is definitely welcome to the art to an effort in improving the motor's driving circuit to act against the kickback voltage.

### SUMMARY OF THE INVENTION

Accordingly, it is the primary object of the present invention to provide a driving switching system applied to motors, in which the damage caused by the kickback voltage can be reduced by switching the in-current MOSFETs based on the kickback voltage across the coil.

In the present invention, the driving switching system includes an H-bridge circuit, at least a kickback voltage detection module and at least a driving module. The H-bridge circuit includes a first PMOSFET, a first NMOSFET, a second PMOSFET and a second NMOSFET. The first NMOSFET connects with the first PMOSFET to have a first connection terminal, and the second NMOSFET connects with the second PMOSFET to have a second connection terminal, in which both the terminals are connected to at least a coil.

The kickback voltage detection module preset with a first threshold voltage and a second threshold voltage connects electrically with the first connection terminal and the second connection terminal, and is used to detect a first kickback voltage at the first connection terminal and a second kickback voltage at the second connection terminal. Based on the first kickback voltage and the second kickback voltage, the kickback voltage detection module can issue a detection signal. The driving module coupled electrically with the kickback voltage detection module is to receive the detection signal. During a first switch stage, a second switch stage and a third switch stage, the motor is driven by switching on/off the first PMOSFET, the second PMOSFET, the first NMOSFET and the second NMOSFET, respectively.

While in the first switch stage, the driving module turns off the first PMOSFET and, as the first kickback voltage reaches the first threshold voltage, the kickback voltage detection module issues the detection signal to the driving module and the first NMOSFET is turned on so as to have a first residual current of the coil to flow through the first NMOSFET, the coil and the second NMOSFET.

While in the second switch stage, the driving module turns off the second NMOSFET and, as the second kickback voltage reaches the second threshold voltage, the kickback voltage detection module issues the detection signal to the driving module and the second PMOSFET is turned on. Further, as the first kickback voltage reaches the first threshold voltage, the kickback voltage detection module issues the detection signal to the driving module, the first PMOSFET is turned on and, on the other hand, the first NMOSFET is forced to turn off so as to have a second residual current to flow through the first PMOSFET, the coil and the second PMOSFET.

While in the third switch stage, the driving module turns off the second PMOSFET and, as the second kickback voltage reaches the first threshold voltage, the kickback voltage detection module issues the detection signal to the driving module and the second NMOSFET is turned on so as to have a third residual current to flow through the second NMOSFET, the coil and the first NMOSFET.

In one embodiment of the present invention, the kickback voltage detection module further includes a third threshold voltage. While in the first switch stage and as the first kickback voltage reaches the third threshold voltage, the kickback voltage detection module further issues the detection signal to the driving module and the first PMOSFET is turned on so as to have the first residual current to further flow through the first PMOSFET, the coil and the second NMOSFET. Further, the first threshold voltage is less than 0, and the third threshold voltage is smaller than the first threshold voltage.

In one embodiment of the present invention, the kickback voltage detection module further includes a fourth threshold voltage. While in the second switch stage and as the second kickback voltage reaches the fourth threshold voltage, the kickback voltage detection module further issues the detection signal to the driving module and the second NMOSFET is turned on so as to have the second residual current to further flow through the first PMOSFET, the coil and the second NMOSFET. Further, the first PMOSFET and the second PMOSFET couples electrically with a source voltage, the second threshold voltage is larger than the source voltage, and the fourth threshold voltage is larger than the second threshold voltage.

In one embodiment of the present invention, while in the third switch stage and as the second kickback voltage reaches the third threshold voltage, the kickback voltage detection module further issues the detection signal to the driving module and the second PMOSFET is turned on so as to have the third residual current to further flow through the second PMOSFET, the coil and the first NMOSFET. Further, prior to the first switch stage, the driving module engages electrically the first PMOSFET and the second NMOSFET so as to have a current to flow through the first PMOSFET, the coil and the second NMOSFET, such that the driving module introduces a first current phase to drive the motor.

In one embodiment of the present invention, after the second switch stage and as the kickback voltage detection module senses that the first kickback voltage is zero, the driving module engages electrically the second PMOSFET and the first NMOSFET so as to have the current to flow through the second PMOSFET, the coil and the first NMOSFET, which is the second current phase to drive the motor.

By providing the driving switching system for motors in accordance with the present invention, the timing of the first kickback voltage reaching the first threshold voltage, which defines the first switch stage, would push the system to flow the current through the first NMOSFET; the timing of the second kickback voltage reaching the second threshold voltage, which defines the second switch stage, would push the system to flow the current through the second PMOSFET and, as the first kickback voltage reaches the first threshold voltage, further to flow the current through the first PMOSFET and the first NMOSFET is forced to turn off; and, the timing of the second kickback voltage reaching the first threshold voltage, which defines the third switch stage, would push the system to flow the current through the second NMOSFET. Accordingly, based on the determination of whether the kickback voltage reaches the first threshold voltage, current flow is switched to the preferred MOSFET, and thus the kickback voltage can be reduced so as to protect the MOSFETs and ensure the driving efficiency upon the motor.

Further, in the preset invention, as the kickback voltage reaches the second threshold voltage, one more MOSFET is selected to share the load and thus to reduce the kickback voltage immediately. Upon such an arrangement, the safety and efficiency in driving the motor can be definitely enhanced.

All these objects are achieved by the driving switching system applied to motors described below.

### BRIEF DESCRIPTION OF THE DRAWINGS

The present invention will now be specified with reference to its preferred embodiment illustrated in the drawings, in which:

FIG. 1 is a schematic view of the preferred driving switching system applied to motors in accordance with the present invention;

FIG. 2 through FIG. 2B illustrate schematically the switching of FIG. 1 in the first switching stage;

FIG. 3 through FIG. 3A illustrate schematically the switching of FIG. 1 in the second switching stage; and

FIG. 4 through FIG. 4B illustrate schematically the switching of FIG. 1 in the third switching stage.

### DESCRIPTION OF THE PREFERRED EMBODIMENT

The invention disclosed herein is directed to a driving switching system applied to motors. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

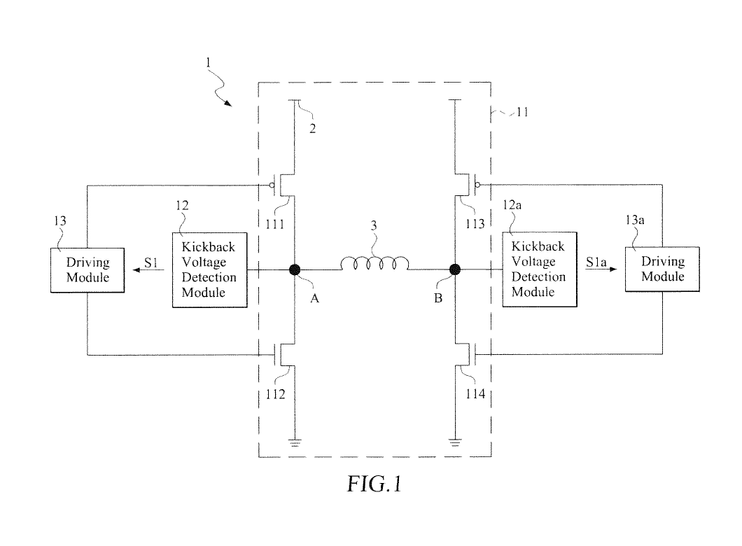

Referring now to FIG. 1, a preferred embodiment of the driving switching system for motors in accordance with the present invention is schematically shown. As shown, the system 1 for driving the motor (not shown in the figure) includes an H-bridge circuit 11, two kickback voltage detection modules 12, 12a and two driving modules 13, 13a.

The H-bridge circuit 11 includes a first PMOSFET 111, a first NMOSFET 112, a second PMOSFET 113 and a second NMOSFET 114.

The first PMOSFET 111 has a first source end (not labeled in the figure), a first drain end (not labeled in the figure) and a first gate end (not labeled in the figure). The first source end of the first PMOSFET 111 is electrically connected to a power source 2 with a VDD voltage.

The first NMOSFET 112 has a second source end (not labeled in the figure), a second drain end (not labeled in the figure) and a second gate end (not labeled in the figure). The second source end is grounded to have a ground voltage VSS, and the second drain end is electrically connected to the first drain end so as to form a first connection terminal A.

The second PMOSFET 113 has a third source end (not labeled in the figure), a third drain end (not labeled in the figure) and a third gate end (not labeled in the figure). The third source end of the second PMOSFET 113 is electrically connected to the power source 2.

The second NMOSFET 114 has a fourth source end (not labeled in the figure), a fourth drain end (not labeled in the figure) and a fourth gate end (not labeled in the figure). The fourth source end is grounded, and the fourth drain end is electrically connected to the third drain end so as to form a second connection terminal B. The first connection terminal A and the second connection terminal B are electrically connected with a coil 3.

In the present invention, the kickback voltage detection modules 12, 12a are both preset with a first threshold voltage, a second threshold voltage, a third threshold voltage and a fourth threshold voltage. The first threshold voltage is less than zero. (In the present invention, for the second source end and the fourth source end are both grounded to VSS, so the preset value for the first threshold voltage is less than zero, which is the potential of VSS) The third threshold voltage is smaller than the first threshold voltage, while the second threshold voltage is larger than the VDD of the power source 2. The fourth threshold voltage is greater than the second threshold voltage, and thus greater than the VDD. In addition, the kickback voltage detection module 12 is electrically connected to the first connection terminal A, while another kickback voltage detection module 12a is electrically connected to the second connection terminal B.

The kickback voltage detection module 12 is to detect a first kickback voltage at the first connection terminal A so as to evaluate whether or not the first kickback voltage reaches the first threshold voltage, the second threshold voltage, the third threshold voltage or the fourth threshold voltage. As a positive detection is met, a corresponding detection signal S1 is issued. On the other hand, the kickback voltage detection module 12a is to detect a second kickback voltage at the second connection terminal B so as to evaluate whether or not the second kickback voltage reaches the first threshold voltage, the second threshold voltage, the third threshold voltage or the fourth threshold voltage. As a positive detection is met, a corresponding detection signal S1a is issued.

The driving module 13 coupled electrically with the kickback voltage detection module 12 is to receive the detection signal S1 from the kickback voltage detection module 12. During a first switch stage, a second switch stage and a third switch stage, the motor is driven by switched around on the first PMOSFET 111 and the first NMOSFET 112.

The driving module 13a coupled electrically with the kickback voltage detection module 12a is to receive the detection signal S1a from the kickback voltage detection module 12a. During a first switch stage, a second switch stage and a third switch stage, the motor is driven by switched around on the second PMOSFET 113 and the second NMOSFET 114.

In practice, in the preferred embodiment of the present invention, the process to drive the motor is actually separated into the first switch stage, the second switch stage and the third switch stage. In view of the direction change of the coil current, only two switch stages are included. The driving modules 13, 13a in any of the first switch stage, the second switch stage and the third switch stage are to receive the detection signals S1 and S1a and evaluate if any of the first kickback voltage threshold, the second kickback voltage threshold, the third kickback voltage threshold and the fourth kickback voltage threshold is reached. Upon the evaluation results, the driving modules 13, 13a proceed to perform switching of current flow through around the first PMOSFET 111, the first NMOSFET 112, the second PMOSFET 113 and the second NMOSFET 114.

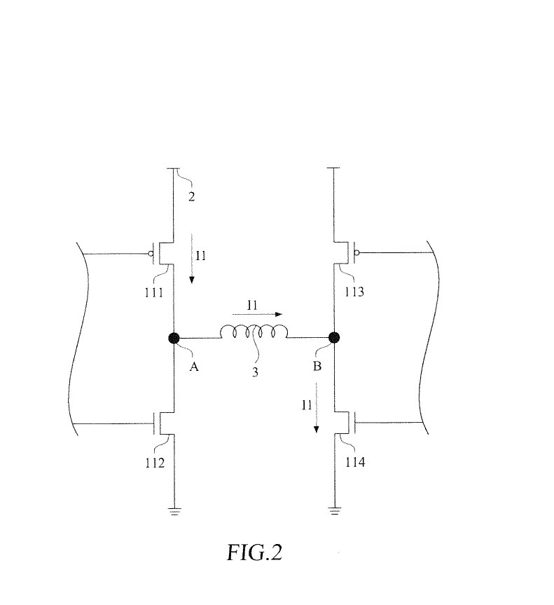

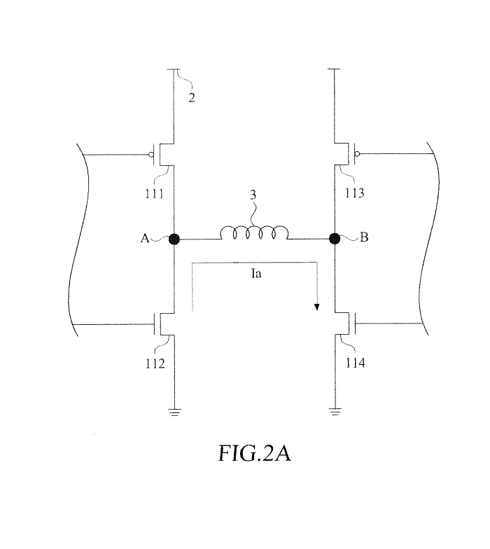

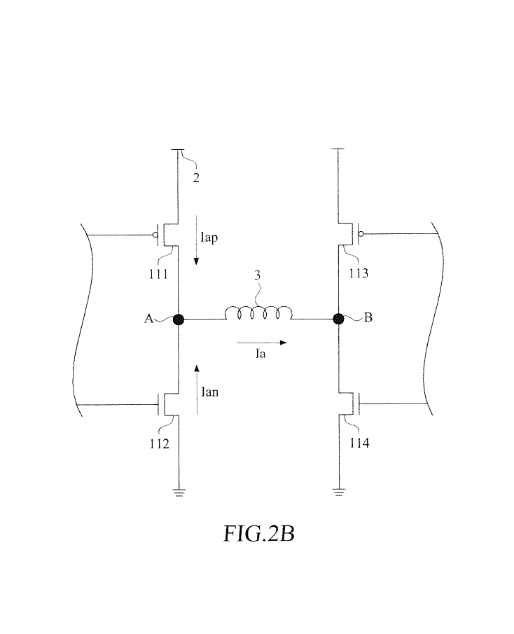

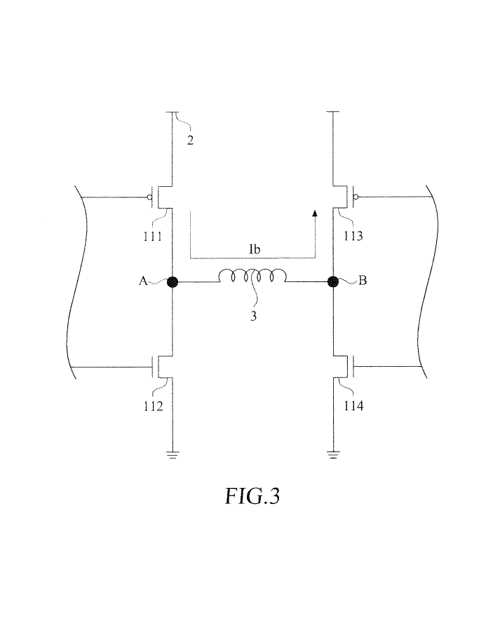

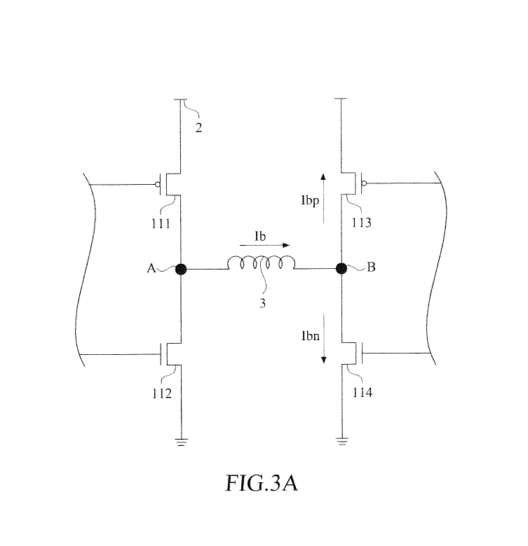

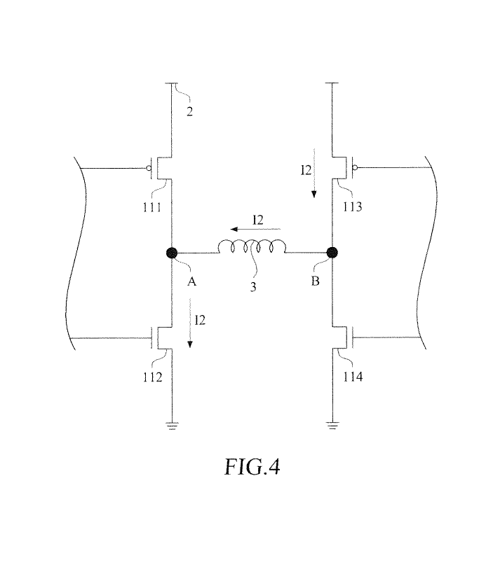

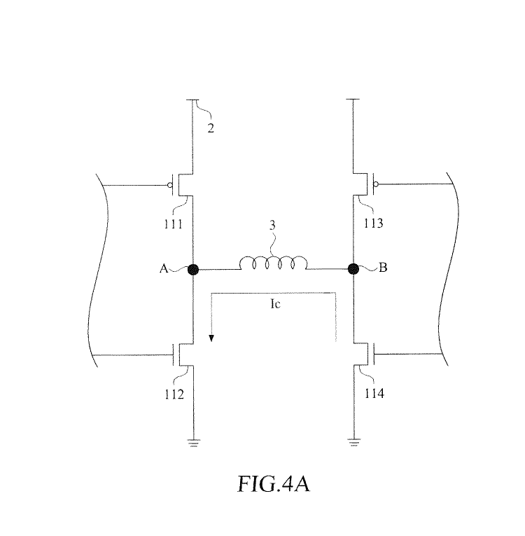

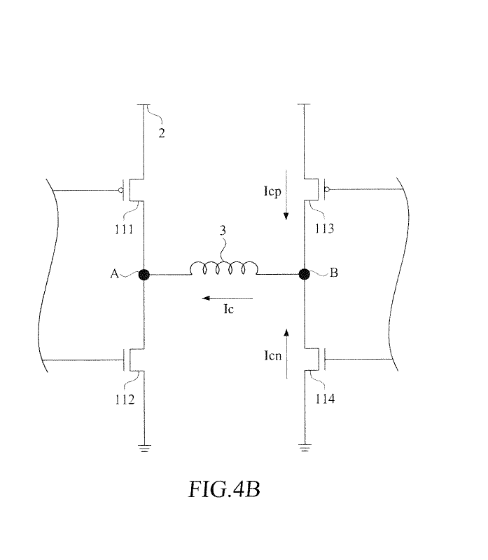

Besides FIG. 1, please also refer to FIG. 2 through FIG. 2B, FIG. 3 through FIG. 3A and FIG. 4 through FIG. 4B, in which the switching of FIG. 1 in the first, second and third switch stages are illustrated schematically, respectively.

As shown, prior to the first switch stage, the driving modules 13, 13a engages electrically respectively the first PMOSFET 111 and the second NMOSFET 114, such that the first current flow I1 can flow from the first PMOSFET 111, the coil 3 and the second NMOSFET 114. Thereby, the driving modules 13, 13a can introduce a first current phase to drive the motor. As shown in FIG. 2, at this time, a pulse width modulation (PWM) signal is “on” and applied to the first PMOSFET 111, the voltage at the first connection terminal A is VDD−ΔVa, and the voltage at the second connection terminal B is VSS+ΔVb, in which the aforesaid and the below ΔVa and ΔVb are different values and depend upon the current flowing through the corresponding MOSFETs.

While in the first switch stage, the driving module 13 turns off the first PMOSFET 111 and, as the first kickback voltage at the first connection terminal A reaches the first threshold voltage, the kickback voltage detection module 12 issues the detection signal S1 to the driving module 13 and the first NMOSFET 112 is turned on so as to have a first residual current Ia of the coil 3 to flow through the first NMOSFET 112, the coil 3 and the second NMOSFET 114. As shown in FIG. 2A, at this time, the pulse width modulation (PWM) signal is “off”, the voltage at the first connection terminal A is VSS−ΔVa, and the voltage at the second connection terminal B is VSS+ΔVb.

Furthermore, while in the first switch stage and as the first kickback voltage reaches the third threshold voltage, the kickback voltage detection module 12 would issue again a detection signal S1 to the driving module 13 and the first PMOSFET 111 is turned on so as to have the first residual current Ia (originally flowing through the first NMOSFET 112, the coil 3 and the second NMOSFET 114) to further flow through the first PMOSFET 111, the coil 3 and the second NMOSFET 114. As shown in FIG. 2B, the first residual current Ia is consisted of the current Iap from the first PMOSFET 111 and the current Ian from the first NMOSFET 112. In addition, the PWM signal is “off”, the voltage at the first connection terminal A is VSS−ΔVa, and the voltage at the second connection terminal B is VSS+ΔVb.

Prior to the second switch stage, the current flow is shown in either FIG. 2A or FIG. 2B. At this time, the PWM signal is “on” and applied to the second NMOSFET 114, the voltage at the first connection terminal A is VSS−ΔVa, and the voltage at the second connection terminal B is VSS+ΔVb. While in the second switch stage, the driving module 13a turns off the second NMOSFET 114 and, as the second kickback voltage reaches the second threshold voltage, the kickback voltage detection module 12a issues the detection signal S1a to the driving module 13a and the second PMOSFET 113 is turned on. Further, for the first kickback voltage still exists at the first connection terminal A, as the first kickback voltage reaches the first threshold voltage, the kickback voltage detection module 12 issues the detection signal s1 to the driving module 13 and the first PMOSFET 111 is turned on and, on the other hand, the first NMOSFET 112 is forced to be turned off so as to have a second residual current Ib to flow through the first PMOSFET 111, the coil 3 and the second PMOSFET 113. At this time as shown in FIG. 3, the second PMOSFET 113 is turned on, the voltage at the first connection terminal A is VSS−ΔVa, and the voltage at the second connection terminal B is VSS+ΔVb.

While in the second switch stage and as the second kickback voltage reaches the fourth threshold voltage, the kickback voltage detection module 12a would issue the detection signal S1a to the driving module 13a and the second NMOSFET 114 is turned on so as to have the second residual current Ib (originally flowing through the first PMOSFET 111, the coil 3 and the second PMOSFET 113) to further flow through the first PMOSFET 111, the coil 3 and the second NMOSFET 114. As shown in FIG. 3A, the second residual current Ib is bifurcated to the current Ibp through the second PMOSFET 113 and the current Ibn through the second NMOSFET 114. In addition, the PWM signal is “off”, the voltage at the first connection terminal A is VSS−ΔVa, and the voltage at the second connection terminal B is VSS+ΔVb.

After the second switch stage, as the kickback voltage detection module 12 detects that the first kickback voltage at the first connection terminal A is zero, which also means the current of the coil 3 is zero, the driving modules 13, 13a are to turn on the first NMOSFET 112 and the second PMOSFET 113, respectively, so as to have the current I2 to flow through the second PMOSFET 113, the coil 3 and the first NMOSFET 112. At this time as shown in FIG. 4, the PWM signal is “on”, the voltage at the first connection terminal A is VSS+ΔVa, and the voltage at the second connection terminal B is VDD−ΔVb. Then, the driving module 13, 13a introduce the second current phase to drive the motor, and, after the driving module 13a turns off the second PMOSFET 113, the operation is to enter the third switch stage.

While in the third switch stage, the driving module 13a turns off the second PMOSFET 113 and, as the second kickback voltage reaches the first threshold voltage, the kickback voltage detection module 12a issues the detection signal S1a to the driving module 13a and the second NMOSFET 114 is turned on so as to have a third residual current Ic of the coil 3 to flow through the second NMOSFET 114, the coil 3 and the first NMOSFET 112. As shown in FIG. 4A, the PWM signal is “off”, the voltage at the first connection terminal A is VSS+ΔVa, and the voltage at the second connection terminal B is VSS−ΔVb.

Further, while in the third switch stage and as the second kickback voltage reaches the third threshold voltage, the kickback voltage detection module 12a issues the detection signal S1a to the driving module 13a and the second PMOSFET 113 is turned on so as to have the third residual current Ic (originally flowing through the second NMOSFET 114, the coil 3 and the first NMOSFET 112) to further flow through the second PMOSFET 113, the coil 3 and the first NMOSFET 112. As shown in FIG. 4B, the third residual current Ic is consisted of the current Icp from the second PMOSFET 113 and the current Icn from the second NMOSFET 112. In addition, as the PWM signal is “off”, the voltage at the first connection terminal A is VSS+ΔVa, and the voltage at the second connection terminal B is VSS−ΔVb.

In summary, by introducing the driving switching system applied to motors in accordance with the present invention, due to various MOSFET switching are determined by being based on if the kickback voltage reaches the first preset threshold voltage, the kickback voltage can be reduced to a degree to protect the MOSFETs and enhance the motor's driving efficiency. Further, in the present invention, if the second threshold voltage is reached by the kickback voltage, an additional MOSFET is chosen to flow the current so as to rapidly reduce the kickback voltage and thus to further ensure the safety of motor driving and the driving efficiency.

While the present invention has been particularly shown and described with reference to a preferred embodiment, it will be understood by those skilled in the art that various changes in form and detail may be without departing from the spirit and scope of the present invention.

What is claimed is:

1. A driving switching system for a motor, comprising:
an H-bridge circuit, further including:
a first P-type MOSFET (Metal-Oxide-Semiconductor Field-Effect Transistor);
a first N-type MOSFET (NMOSET), connecting electrically with the first P-type MOSFET (PMOSET) and thereby forming a first connection terminal;
a second PMOSFET; and
a second NMOSFET, connecting electrically with the second PMOSFET and thereby forming a second connection terminal;
wherein the first connection terminal and the second connection terminal are connected with at least a coil;
at least a kickback voltage detection module, preset with a first threshold voltage and a second threshold voltage, connected electrically with the first connection terminal and the second connection terminal for detecting respectively a first kickback voltage at the first connection terminal and a second kickback voltage at the second connection terminal, generating a detection signal according to the first kickback voltage and the second kickback voltage; and
at least a driving module for driving the motor, connected electrically with the kickback voltage detection module so as therefrom to receive the detection signal and turns on and off the first PMOSFET, the second PMOSFET, the first NMOSFET, and the second NMOSFET in the first switch stage, the second switch stage, and the third switch stage;
wherein, while in the first switch stage, the driving module turns off the first PMOSFET and, as the first kickback voltage reaches the first threshold voltage, the kickback voltage detection module issues the detection signal to the driving module and the first NMOSFET is turned on so as to have a first residual current of the coil to flow through the first NMOSFET, the coil and the second NMOSFET;
wherein, while in the second switch stage, the driving module turns off the second NMOSFET and, as the second kickback voltage reaches the second threshold voltage, the kickback voltage detection module issues the detection signal to the driving module and the second PMOSFET is turned on; further, wherein, as the first kickback voltage reaches the first threshold voltage, the kickback voltage detection module issues the detection signal further to the driving module and the first PMOSFET is turned on and, on the other hand, turns off enforcedly the first NMOSFET so as to have a second residual current to flow through the first PMOSFET, the coil and the second PMOSFET;
wherein, while in the third switch stage, the driving module turns off the second PMOSFET and, as the second kickback voltage reaches the first threshold voltage, the kickback voltage detection module issues the detection signal to the driving module and the second NMOSFET is turned on so as to have a third residual current to flow through the second NMOSFET, the coil and the first NMOSFET.

2. The driving switching system for a motor according to claim 1, wherein the kickback voltage detection module further includes a third threshold voltage; wherein, while in the first switch stage and as the first kickback voltage reaches the third threshold voltage, the kickback voltage detection module further engages electrically the driving module with the first PMOSFET so as to have the first residual current to further flow through the first PMOSFET, the coil and the second NMOSFET.

3. The driving switching system for a motor according to claim 2, wherein the first threshold voltage is less than 0, and the third threshold voltage is smaller than the first threshold voltage.

4. The driving switching system for a motor according to claim 1, wherein the kickback voltage detection module further includes a fourth threshold voltage; wherein, while in the second switch stage and as the second kickback voltage reaches the fourth threshold voltage, the kickback voltage detection module further engages electrically the driving module to turn on the second NMOSFET so as to have the second residual current to further flow through the first PMOSFET, the coil and the second NMOSFET.

5. The driving switching system for a motor according to claim 4, wherein the first PMOSFET and the second PMOSFET couples electrically with a source voltage, the second threshold voltage is larger than the source voltage, and the fourth threshold voltage is larger than the second threshold voltage.

6. The driving switching system for a motor according to claim 1, wherein, while in the third switch stage and as the second kickback voltage reaches the third threshold voltage, the kickback voltage detection module further engages electrically the driving module to turn on the second PMOSFET so as to have the third residual current to further flow through the second PMOSFET, the coil and the first NMOSFET.

7. The driving switching system for a motor according to claim 1, wherein, prior to the first switch stage, the driving module turns on the first PMOSFET and the second NMOSFET so as to have a current to flow through the first PMOSFET, the coil and the second NMOSFET, such that the driving module introduces a first current phase to drive the motor.

8. The driving switching system for a motor according to claim 7, wherein, after the second switch stage and as the kickback voltage detection module senses that the first kickback voltage is zero, the driving module turns on the second PMOSFET and the first NMOSFET so as to have the current to flow through the second PMOSFET, the coil and the first NMOSFET, such that the driving module introduces a second current phase to drive the motor to step into the third switch stage after the driving module turns off the second PMOSFET.
